(19) United States
(12) Patent Application Publication
(10) Pub. No.: US 2010/0214998 A1
(43) Pub. Date: Aug. 26, 2010

(54) Network Management Device and Packet Transfer Device

(75) Inventors: Jun Hirano, Kanagawa (JP); Takashi Aramaki, Osaka (JP); Tien Ming Benjamin Koh, Singapore (SG); Chan Wah Ng, Singapore (SG); Chun Keong Benjamin Lim, Singapore (SG); Pek Yew Tan, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/527,540

(22) PCT Filed: Feb. 22, 2008
(86) PCT No.: PCT/JP2008/000317

§ 371 Date: Aug. 17, 2009

(30) Foreign Application Priority Data
Feb. 23, 2007 (JP) 2007-044730

(51) Int. Cl. H04W 72/04

(52) U.S. Cl. 370/329

(57) ABSTRACT

A technique to optimize packet transfer in a network is disclosed. According to this technique, a mobile node (MN) 1000 having a plurality of interfaces transmits a filter rule where setting conditions are defined to each of MAG (motility access gateway) 1060 and MAG 1080 connected for the purpose of setting the packet received by each of the interfaces. MAG transfers the received filter rule to a local mobility anchor (LMA) 1010. After analyzing the filter rule, LMA specifies the network node where the filter rule should be reflected and updates the filter rule only to this specific network node. For instance, in case MN desires that a packet from CN 1090 is received via a path 1002, LMA manages that a packet destined to MN as transmitted from CN is to be transferred to MAG 1060 with respect to MAG 1020.

### TECHNICAL FIELD

The present invention relates a field of communication technique in a system of packet-exchange type data communication network system. In particular, the invention relates to a network management device and a packet transfer device for mobile management (position management) of a mobile node (mobile terminal), which moves in a communication network domain, and also for management of a packet transfer path in the network.

### BACKGROUND ART

For a mobile user, it is essential that connection to Internet is constantly maintained even when it is moving. When the user moves between networks, IP (Internet Protocol) address is changed, but this problem is solved by the introduction of mobile IP.

On the other hand, in Monami6 (Mobile Nodes and Multiple Interfaces in IPv6) working group of the IETF (Internet Engineering Task Force), the functions are provided, by which the advantages of multi-mode can be demonstrated to full extent to a mobile node, which has a plurality of interfaces (multi-interface). The multi-interface node can register a plurality of care-of addresses acquired at the interfaces on a home agent. As a result, the home agent can comprehend that the mobile node can reach via a plurality of paths. This technique of multi-interface has its purpose in designating the interface, which is to receive a packet. Also, a rule to define as to which of care-of addresses the packet is to be transmitted may be given in some cases in a stream of data packet (i.e. a flow).

In recent years, the support of local IP mobility has been provided. The local IP mobility is an IP mobility in an area where network topology (connection mode of network) is limited. As a condition where local mobility is applicable, the arrangement of wireless LAN (WLAN) in a large scale campus (e.g. in a university campus) is known. A user, who is in an area of a campus, can receive services such as e-mail, retrieval, web surfing, etc. while the user is moving within the university campus.

However, it cannot be regarded as a very good expansion to accommodate all of WLAN access points in a campus area within a single broadcast domain. Also, there is a case where a part of the campus cannot be covered by a single VLAN (Virtual Local Area Network) from some reasons (e.g. a case where different access techniques are adopted at a certain link). In such case, it is desirable to divide the campus to the last-hop link where each is provided by one or more access routers. Therefore, it is necessary to use some kind of localized mobility management technique in order to have an invariable (constant) IP address, which can be used within each area (each area provided by access router) in the university campus.

In the IETF, a localized mobility management protocol is designed in the working group of “network-based localized mobility management” (NetLMM).

In the Non-Patent Document 1 as given below, a localized mobility management protocol is introduced, which carries out IP mobility management by limiting to an area within access domain (may also be called “NetLMM domain”). According to this protocol, mobility is localized by admitting the change associated with the mobility within the access network.

When a mobile node is connected to a NetLMM infrastructure, the mobile node must arrange the address relating to LMA (Local Mobility Anchor), which provides services by using state-full address arrangement processing or state-less address arrangement processing. Therefore, when the mobile node is connected to MAG (Mobile Access Gateway), MAG transmits a position registration message including its own identification information (ID) and ID of the mobile node to LMA.

To this message, LMA sends a response by a position registration acknowledgment message containing a NetLMM prefix, which is to be inserted in a router notification from MAG to the mobile node. Then, MAG transmits a router notification (including the NetLMM prefix) to the connected mobile node. When address arrangement is completed, MAG registers the address of the mobile node at LMA by transmitting an MN address setup message containing ID of MAG, ID of MN, address of NetLMM, and ID of tunnel to LMA. To this message, LMA generates transfer state of the packet and transmits an MN address reply message to recognize packet setup to MAG. When the MN address setup reply message to indicate approval is received, MAG generates a transfer state relating to the packet destined to the mobile node.

[Patent Document 1] U.S. Pat. No. 6,985,454.

### [Patent Document 2] U.S. Patent Application Publication No. 2004/0120502.

[Non-Patent Document 1] Henrik Levkowetz, et al.: “The NetLMM Protocol”; Internet Engineering Task Force Internet Draft: draft-giaretta-netlmm-dt-protocol-02.txt; Work-In-Progress; 5 Oct. 2006.

However, when services are provided for a multiple of users in a local access network domain, problems may arise in scalability of the method of Monami6. The capability of microprocessor is rapidly increasing, and it is anticipated that users would engage in games, audio communication, data download, etc. at the same time, and a mobile node would perform communication simultaneously with a plurality of correspondent nodes. In such case, each mobile node sets up various types of flow filtering rules for the processing of each flow.

However, each of the users may have a plurality of flow filtering rules, and when there are a multiple of users, very high load may be applied on memory of each network node or on processing and storage of the rules. Although the methods for optimization of overlay network are known, there is no definite solution for the problems when flow filtering services are provided in the overlay network.

Further, according to the technique disclosed in the Patent Document 1 as given above, it is possible to transmit packets to a mobile node via a plurality of routes. This technique has high reliability and provides effects useful for the mobility of local access network domain, but there may be a network where a multiple of mobile nodes are operating and are requesting services and it is not scalable. In such case, the introduction of the technique disclosed in the Patent Document 1 may give adverse effect instead.

A plurality of types of access networks of central soft switch spanning are disclosed in the Patent Document 2 as given above. A mobile node first registers a calling position at a soft switch. The soft switch guarantees the reachability to the mobile node via a plurality of different types of access networks.

Although the technique disclosed in the Patent Document 2 is useful for the operation in local access network domain, a problem arises that the presence of the soft switch for centralized management may become a bottleneck. The soft switch has an arrangement to cause a bottleneck because it carries out concentrative management at a single point. This means that the effect of dispersion of processing of the mobile node with a plurality of interfaces may be effaced. Also, when a trouble may occur in the soft switch, a problem may be caused that the system is low in the ability for the recovery.

### DISCLOSURE OF THE INVENTION

To overcome the problems as described above, it is an object of the present invention to provide a network management device and a packet transfer device, by which it is possible to optimize packet transfer in a network. Also, it is another object of the invention to provide a network management device and a packet transfer device, which can improve operation efficiency on network side while supporting the use of a plurality of interfaces by each node when a node with a plurality of interfaces is connected to a localized mobile management domain such as NetLMM domain.

To attain the above object, the present invention provides a network management device, being connectable to a network, and for managing transfer destination of a packet in said network, wherein said network management device comprises:

packet receiving means for receiving a packet from said network;

filter rule extracting means for extracting a filter rule at the time of packet transfer as set up by a mobile node from the packet received by said packet receiving means;

transfer path specifying means for specifying said packet transfer device, being influenced by said filter rule in a packet transfer device present within said network by inspecting said filter rule extracted by said filter rule extracting means; and

filter rule notifying means for extracting information necessary for said packet transfer device as specified by said transfer path specifying means from the information contained in said filter rules and for notifying the information to said packet transfer device as specified by said transfer path specifying means.

With the arrangement as described above, it is possible to optimize packet transfer in a network with the least amount of signalings by notifying information relating to filter rules only to a packet transfer device where a packet is transferred according to a filter rule as requested by a mobile node.

Also, in addition to the above arrangement, the present invention provides a network management device as described above, wherein there is provided packet transfer destination notifying means for notifying a new transfer destination of said packet as defined in said filter rule to said packet transfer device as specified by said transfer path specifying means.

With the arrangement as described above, a mobile node can set up an optimized packet transfer path, which does not pass through the network management device itself, based on a filter rule as requested by the mobile node.

Further, in addition to the above arrangement, the present invention provides the network management device as described above, wherein there is provided transfer destination acquiring means for acquiring a new transfer destination of said packet as defined in said filter rule.

With the arrangement as described above, the network management device can refer to information provided by local or remote information services, for instance, and to specify transfer destination of the packet to realize the optimized path.

Also, to attain the above object, the present invention provides a packet transfer device, being connectable to a network and for transferring a packet in said network, wherein said packet transfer device comprise:

filter rule storage means for storing a filter rule to define transfer condition to transfer a specific packet;

packet transfer means for transferring said packet according to said filter rule stored in said filter rule storage means;

filter rule receiving means for receiving a filter rule to define transfer condition of a specific packet from a network management device, being connected to said network and for managing transfer destination of said packet; and

filter rule updating means for updating said filter rule as stored in said filter rule storage means by using said filter rule received by said filter rule receiving means.

With the arrangement as described above, by updating the information relating to the filter rules as received from the network management device, it is possible to optimize packet transfer in a network with the least amount of signalings.

Further, in addition to the above arrangement, the present invention provides a packet transfer device as described above, wherein said packet transfer device comprises:

filter rule request receiving means for receiving a filter rule to define transfer condition of a specific packet from a mobile node; and

filter rule transfer means for transferring said filter rule received by said filter rule request receiving means to a network management device, being connected to said network and for managing transfer destination of said packet.

With the arrangement as described above, it is possible to intensively concentrate the filter rules as requested by a mobile node to a network management device, which manages transfer destination of the packet in a network.

Also, in addition to the above arrangement, the present invention provides the packet transfer device as described above, wherein said packet transfer device comprises:

packet transfer destination acquiring means for acquiring a new transfer destination of said packet as defined by said filter rule; and

transfer destination memorizing means for memorizing said new transfer destination as acquired by said packet transfer destination acquiring means by associating with said filter rule, wherein:

said packet transfer means is so designed that said packet is transferred to said new transfer destination associated with said filter rule when said packet transfer means transfers said packet according to said filter rule.

With the arrangement as described above, it is possible to perform packet transfer via the optimized path based on the filter rules as requested by the mobile node.

With the arrangement as described above, the present invention provides such effects that the packet transfer in a network can be optimized.

### BRIEF DESCRIPTION OF THE DRAWINGS

FIG. 1 is a schematical drawing to show an example of network arrangement common to the prior art and to the present invention;

FIG. 2 is a drawing to show an example of a format of a filter message in an embodiment of the present invention;

FIG. 3 is a block diagram to show an example of arrangement of LMA in the embodiment of the invention;

FIG. 4 is a block diagram to show an example of arrangement of MAG in the embodiment of the invention;

FIG. 5 is a flowchart showing an example of operation of LMA in the embodiment of the invention; and

FIG. 6 is a flowchart showing an example of operation of MAG in the embodiment of the invention;

### BEST MODE FOR CARRYING OUT THE INVENTION

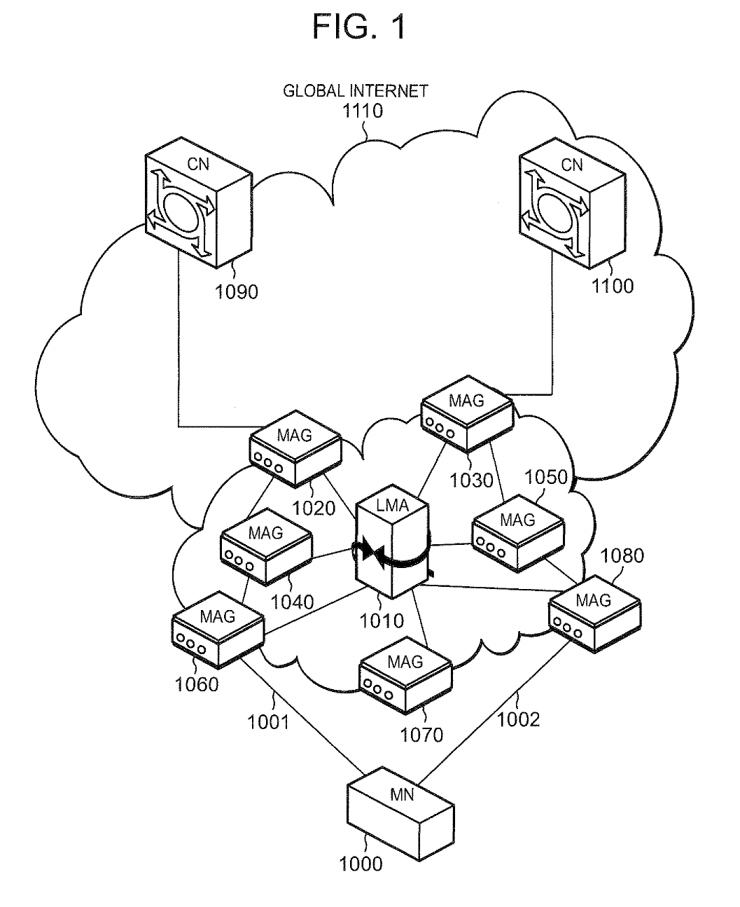

Description will be given below on an embodiment of the present invention by referring to the attached drawings. First, description will be given on an example of a network arrangement, to which the present invention is applied. FIG. 1 shows an example of network arrangement in an embodiment of the invention. In FIG. 1, MN 1000 is subscribed in a mobility service of a local access network domain.

The domain network as shown in FIG. 1 comprises a local mobility anchor (LMA) for managing this domain network and a plurality of mobile access gateways (MAGs) 1020-1080.

MN 1000 receives data streams from two correspondent nodes (CN 1090 and CN 1100). MN 1000 can register a plurality of interfaces (two interfaces to use paths 1001 and 1002) by using Monami6 protocol stack.

Also, MN 1000 can designate a method to transfer the data streams from CN 1090 and CN 1100 respectively. It is supposed here that MN 1000 uses a path 1001 for a data stream from CN 1090 and uses a path 1002 for a data stream from CN 1100. For instance, MN 1000 arranges so that a flow from CN 1090 reaches it (MN 1000) via a path 1001, and it decides that all other flows are separated and separately reach via a path 1002. Here, an example is shown, in which each of CN 1090 and CN 1100 has one flow respectively to MN 1000, while, in reality, one CN may have flows passing though a plurality of different paths to one MN.

For the purpose of realizing the flow filter rules as described above in a NetLMM domain, the filter rule exchange processing as defined in the Monami6 working group can be used. In the present invention, attention is given to the fact that the functions of LMA and the functions of a home agent are similar to each other, and it is so designed that the flow filter rules are registered at LMA. Specifically, the LMA according to the present invention has such arrangement that processing functions of the flow filter rules (such as storage of the flow filter rules or execution of processing based on the flow filter rules) are added to LMA as defined in the past.

Therefore, when a packet destined to MN 1000 (e.g. a packet coming from a global Internet 1110) enters the domain, the packet is first transferred to LMA 1010 so that routing is carried out within the NetLMM domain.

Then, LMA 1010 refers to the registered filter rules and checks whether a filter rule is present or not, which concurs with input flow of the received packet. If there is the filter rule, which concurs with the input flow, LMA 1010 sends the packet belonging to the flow toward MAG by tunneling, which is associated by the filter rule.

The arrangement and the operation according to the present invention as described above are advantageous in that the filter rules can be easily applied to the packet transfer at the NetLMM by integrating the functions of the flow filter rules to LMA 1010. On the other hand, in the arrangement and the operation according to the present invention as described above, the packet coming to a certain NetLMM domain is first delivered to LMA 1010, and its transfer destination (the next hop) is decided at LMA 1010. As a result, there is possibility that the LMA 1010 may become a bottleneck. Also, there may be a multiple of MNs at a single NetLMM. Each of the MNs may have enormous numbers of flow filters.

Accordingly, the packet transfer to LMA 1010 may be delayed or the processing may be retarded because a load occurs in the processing of LMA 1010. Further, vast amount of resources may be consumed at LMA 1010. LMA 1010 must store filter rules of all MNs subscribed in NetLMM domain or must check all data packets with respect to huge list of filters.

To overcome the above problems, it is so arranged according to the present invention that the functions of the flow filter rules are integrated in LMA 1010 to facilitate the application of the filter rules to the packet transfer at the NetLMM, and it is tried to improve operation efficiency on the network side while supporting the use of a plurality of interfaces by a node when a node having a plurality of interfaces is connected to a localized mobile management domain such as the NetLMM domain.

As described below, to the processing functions of the filter rules newly added to LMA 1010 by the present invention, additional functions are added with the purpose of improving the operation efficiency on the network side. According to the present invention, LMA 1010 can selectively update information in a part of the filter rules received from MN 1000 (the information of a part of the filter rules necessary for the transfer of the packet, which MAG must have for packet transfer).

Also, in association with the processing of LMA 1010 of the present invention, functions are also added to MAG. According to the present invention, MAG can perform processing for the packet transfer in accordance with the information of a part of the filter rules received from LMA 1010.

For instance, in the example shown in FIG. 1, MAG 1020 is updated with respect to the filter rules relating to CN 1090. Similarly, at MAG 1030, the filter lists relating to CN 1100 or to all other default traffics are updated.

Detailed description will be given below on operation according to the present invention.

In a preferred embodiment of the present invention, MN 1000 transmits a message including flow filtering rules of interface (matching relation between a packet flow and a packet transfer method) to one of the MAGs connected (i.e. MAG 1060 or MAG 1080). When this message is received, MAG transfers the message to LMA 1010. LMA 1010 acquires the flow filtering rules requested by MN 1000 and judges as to which of MAGs in the NetLMM domain is related to the flow filtering rules as requested.

In the judgment of MAG in relation to the flow filtering rules, consideration may be given not only on the selection of the MAG where the transfer path of the packet is optimized but also on the network topology or on the mode of transfer between network nodes, processing ability of each MAG, etc.

Also, LMA 1010 may refer to information element of a part of the flow filtering rules (e.g. source address of the flow filtering rules) and may select an adequate MAG. For instance, if LMA 1010 comprehends that a data stream from CN 1090 enters the NetLMM domain via MAG 1090, MAG 1020 can be specified as the MAG, which relates to the filter rules corresponding to CN 1090.

Also, LMA 1010 may wait for an input packet from CN 1090. When a packet destined to the NetLMM domain (a packet from CN 1090) is received, MAG 1020 transfers this packet to LMA 1010. LMA 1010 receives the transferred packet and judges that MAG 1020 is the MAG, which is suitable to the filter rules relating to CN 1090. For instance, with regard to the filter rules for wide range such as the rules relating to all other traffics, the method to judge correlation of such MAG with the packet is more useful and scalable. If it is judged that MAG 1020 is related to a plurality of filter rules, LMA 1010 may update MAG 1020 according to a plurality of filter rules. As described above, the filter rules relating to CN 1090 are updated at MAG 1020. For instance, LMA 1010 arranges with respect to MAG 1020 so that the packet transmitted to MN 1000 from CN 1090 is to be transferred to MAG 1060.

When the packet destined to MN 1000 from CN 1090 reaches MAG 1020 under the condition that the flow filtering rules are updated as described above, MAG 1020 performs tunneling of the packet to MAG 1060 instead of transferring the packet to LMA 1010. Then, the packet reaches MN 1000 in accordance with the request (in accordance with the flow filtering rules transmitted by MN 1000) via a path 1001 from MAG 1060. Also, information of MAG 1060, which is a tunnel end point, may be provided from LMA 1010 to MAG 1020.

When the packet destined to MN 1000 reaches MAG 1030 from CN 1100, the packet is first transferred to LMA 1010. LMA 1010 refers to the filter rules requested by MN 1000 and judges that MAG 1030 is adequate for the purpose of transmitting all traffics except the data stream from CN 1090 via the path 1002, and updates MAG 1030.

When a data packet destined to MN 1000 is received from CN 1100, MAG 1030 sends the packet to MAG 1080 by tunneling instead of transferring the packet to LMA 1010. The packet reaches MN 1000 from MAG 1080 via a path 1002 in accordance with a request (i.e. in accordance with the flow filtering rules transmitted by MN 1000). Information of MAG 1080, which is a tunnel end point, may be provided to MAG 1030 from LMA 1010.

Next, description will be given on a new message (a filter message to transmit the filter rules) to be used in the present invention. The new message explained here is merely an example, and the new message is not necessarily required. The message explained here contains a type of information, which is important for operation of the invention, while these messages may be integrated or may be substituted with messages of an existing protocol such as the NetLMM protocol. Even when the message is integrated or substituted with the existing message and the message according to the present invention is realized through integration or substitution with the existing message, the same purpose can be attained and similar effect can be provided as in the case where the new message explained here is used. Also, as the message relating to the present invention, the flow filtering protocol of Monami6 or a related update message as described in any other applicable flow filtering protocol may be re-used.

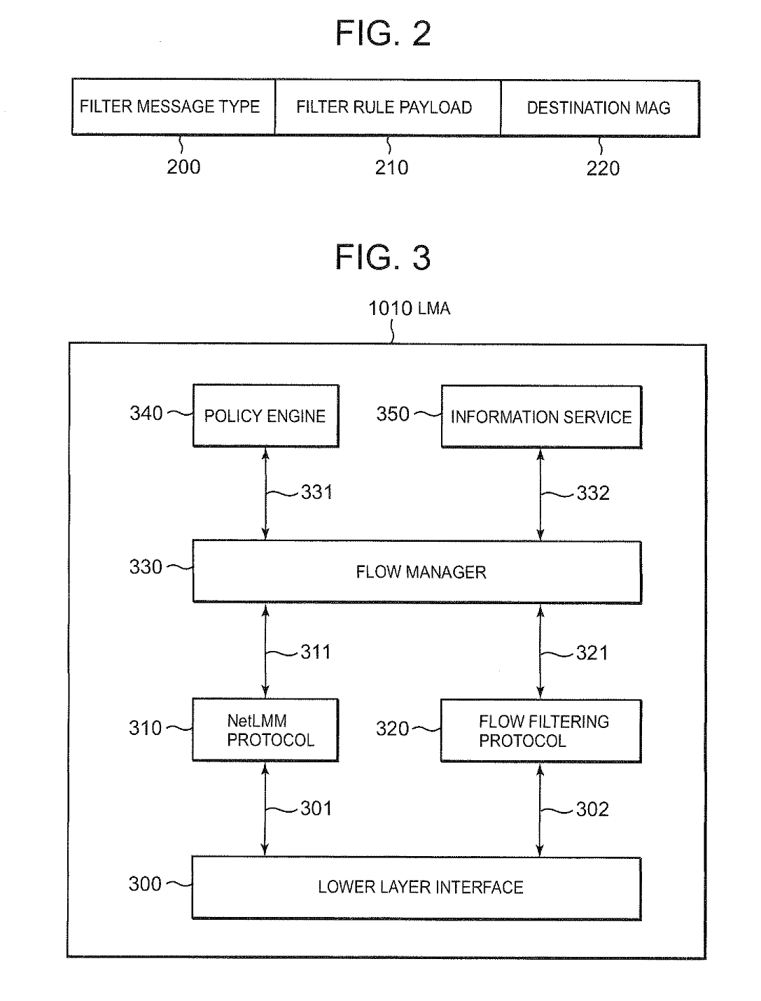

FIG. 2 shows an example of a format of a filter message in the embodiment of the present invention. This filter message is used when a specific flow filtering rule requested from MN 1000 is carried to MAG, which should be updated from LMA 1010.

A filter message type field 200 indicates that this message is a filter message.

Also, a filter rule payload 210 has a variable length, and the filter rule payload 210 includes a flow filtering rule requested from MN 1000.

A destination MAG field 220 is an optional field. In case this destination MAG field 220 is inserted by LMA 1010, an address (or identification information) of MAG is transferred, which is to be the destination when a packet applicable to the filter rule to be carried by the filter rule payload 210. LMA 1010 may transmit a plurality of filter rules in a single filter message and a different value (address) may be set in the destination MAG field 220 of each filter rule. If the MAG, which receives the filter rule, can acquire the information contained in the destination MAG by an arbitrary method (e.g. a method to make inquiry to information service in the NetLMM domain), LMA 1010 may not set up transfer destination in the destination MAG.

An effect similar to that of the filter message as given above may be accomplished by re-using the existing flow filtering protocol message.

To carry out the solution method according to the present invention, new functions must be added to LMA and MAG. Description will be given below on the arrangement of each of LMA and MAG according to the present invention.

FIG. 3 shows an example of arrangement of LMA in an embodiment of the present invention. LMA 1010 as shown in FIG. 3 has a lower layer interface 300, a NetLMM protocol 310, a flow filtering protocol 320, a flow manager 330, a policy engine 340, and an information service 350.

The lower layer interface 300 comprises a physical network access card, and a driver, and a software API (Application Programming Interface) corresponding to it. A message to be transmitted to and received from the network is processed according to the NetLMM protocol 310 or a flow filtering protocol stack 320.

The NetLMM protocol 310 has the function of the NetLMM protocol, while it may have the function of any arbitrary mobile management protocol other than the NetLMM protocol. Also, the flow filtering protocol 320 has the function to perform processing or setting of the flow filtering, and it may be realized by a part of the functions of Monami6, for instance. The flow filtering protocol 320 also has a filter rule storage unit where a filter rule requested from each of the mobile nodes is stored.

The flow manager 330 has the functions to perform operations as given above of the present invention (e.g. analysis processing of the flow filter, judgment processing of MAG, to which the filter rule is related, separation processing of the filter rule, distribution processing to distribute the separated filter rules to each MAG, etc.)

A flow manager entity 330 receives related messages via a path 311 from the NetLMM protocol 310 and via a path 321 from the flow filtering protocol 320. The flow manager 330 may be connected to the policy engine 340 via a path 331. This policy engine 340 may be present at a remote site.

When LMA 1010 receives the flow filtering rule from a mobile node transferred from MAG, the flow manager 330 starts operation. The flow manager 330 retrieves each filter rule and selects which MAG should be updated. Then, the flow manager 330 extracts a filter rule relating to the selected MAG (information of a part of the filter rule) and updates the selected MAG according to the extracted filter rule by using an adequate flow filtering protocol. In this case, the flow manager 330 generates a filter message (see FIG. 2) including the information to be updated and transmits it to the selected MAG.

The flow manager 330 may translate the filter rule from a certain protocol to a protocol of another type. The translation of the filter rule is based on the policy or processing efficiency or it is performed to convert to other type of interpretable protocol by this MAG when the flow filtering protocol 32 is supported by the selected MAG.

The policy engine 340 is a repository of the rule or the policy, which defines whether the present invention is to be put into operation or not. The policy engine 340 may be a local repository or a remote repository.

The information service 350 is a local database or a remote database, which provides static or a quasi-static network information such as network topology or network characteristics. As the remote information service 350, it is possible to use the one defined in the IEEE (The Institute of Electrical and Electronics Engineers, Inc.) 802.21 working group, for instance.

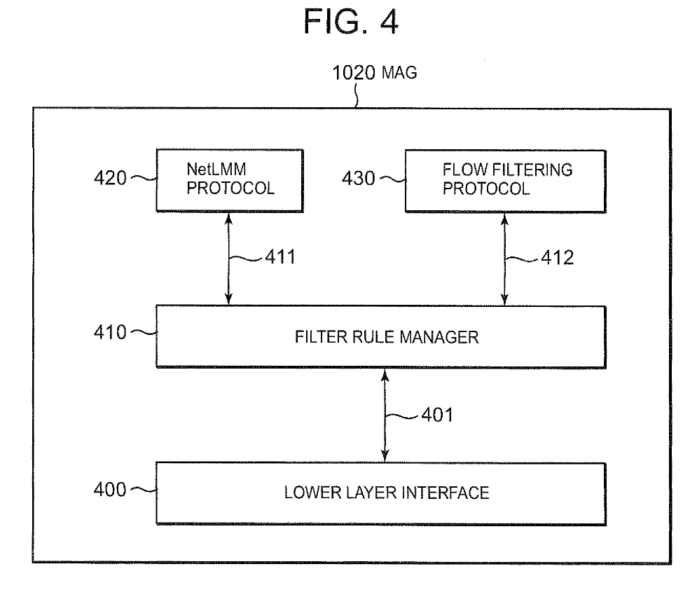

FIG. 4 shows an example of arrangement of MAG in the embodiment of the present invention. The MAG 1020 as shown in FIG. 4 has a lower layer interface 400, a filter rule manager 410, a NetLMM protocol 420, and a flow filtering protocol 430. Although description is given here on the arrangement of MAG 1020 of FIG. 1, each of the other MAGs, i.e. MAG 1030 to MAG 1080, has basically the same arrangement.

The lower layer interface 400 has a physical network access card or a driver, and a software API each corresponding to it. The message to be transmitted to and received from the new network is delivered via a path 401 to the filter rule manager 410 through the lower layer interface 400.

The filter rule manager 410 has the function to transfer the filter rule from the mobile node to LMA 1010. Also, the filter rule manager 410 has the function to update the flow filtering protocol 430 via a path 412 when a filter message is received from LMA 1010. The NetLMM protocol 420 and the flow filtering protocol 430 have the same functions as the functions of the NetLMM protocol 310 and the flow filtering protocol 320 as described above.

In case the filter message contains the NetLMM message, it has the functions to extract information of the filter rule from this message before the packet is delivered via a path 411 to the NetLMM protocol 420 where normal message processing is performed. The filter rule information thus extracted is delivered in an adequate format to the flow filtering protocol 430 and is processed further.

In relation to the flow filtering protocol of Monami6, MN 1000 may transmit two filter rules (e.g. a first filter rule to define that a data stream from CN 1090 is received via a path 1001 and a second filter rule to define that all other traffics are received via a path 1002).

With regard to the first filter rule, a flow is specified by using the address of CN 1090, for instance. For the second filter rule, the filter rule can be set up by the same method as that of the flow filtering protocol, for instance.

After the filter rule request is received, the flow manager 330 of LMA 1010 makes inquiry to the policy engine 340 first via a path 331 and decides whether the operation of the present invention should be carried out or a normal NetLMM protocol processing should be executed.

At the policy engine 340, it may be so arranged that the solution as given above should be used with regard to the first filter rule relating to CN 1090, and that a passive mode should be taken to notify the filter rule after actually receiving the packet with regard to the second filter rule relating to all other traffics.

The flow manager 330 may use the information service 350 via a path 332 and may make inquiry with regard to MAG, which is related to CN 1090 (i.e. a site where a data stream from CN 1090 is inputted to the NetLMM domain). In this case, the information service 350 replies that the data stream from CN 1090 has been received at MAG 1020.

The flow manager 330 generates a filter message with a value of the destination MAG as set up at MAG 1060 (a message including the filter rule relating to the data stream from CN 1090) to the filter filtering protocol 320 via the path 321 and instructs to generate and to transmit it to MAG 1020. As a result, MAG 1020 transfers the data stream from CN 1090 to MAG 1060.

When the transmission of the data packet from CN 1100 to MN 1000 is started, upon receipt of the data packet, MAG 1030 transfers the data packet to LMA 1010 according to the processing of NetLMM protocol or makes inquiry to LMA 1010. LMA 1010 so arranges that MN 1000 sets up the existing rule to all other traffics and updates MAG 1030 according to the filter rule and to the filter message with the value of the destination MAG 1080.

In the operation in the passive mode, it is advantageous in that no load due to the filter rule is applied on the NetLMM domain, which may not be actually used, and that the scalability of the above solution is increased.

This does not necessarily mean that all filter rules must be notified to MAG, and it may be so arranged that LMA transfers the data packet with an applicable filter rule in case the processing load on a specific MAG is big and the processing load should not be increased any more or in case processing ability of LMA has some surplus and flexibility. Further, the processing amount to be shared between LMA and MAG may be dynamically changed depending on the conditions of LMA and MAG. To confirm the conditions, it may be designed that LMA and MAG may exchange the messages of inquiry and notification on the current processing amount.

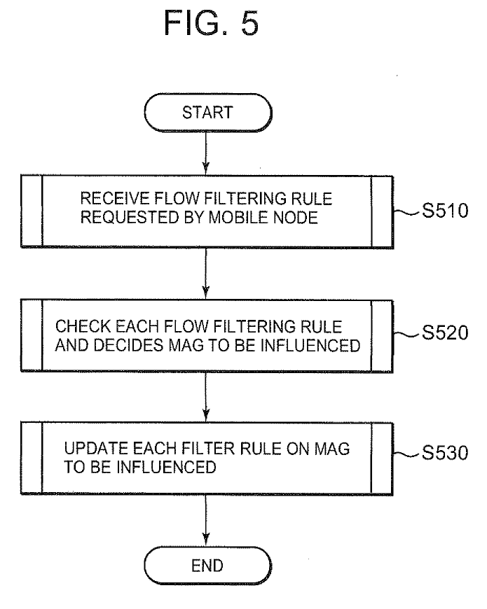

FIG. 5 shows an example of operation of LMA in the embodiment of the invention. When LMA receives the flow filtering rule requested by the mobile node (Step S510), after checking and verifying legitimacy and authenticity of the message containing the flow filtering rule, LMA makes inquiry to the policy engine 340 and specifies proper operation principle as defined by the policy.

In case it is defined by the policy that LMA should carry out the solution method according to the present invention, LMA inspects each flow filtering rule as requested by the mobile node and decides the MAG, which is influenced by each of the flow filtering rules (Step S520). LMA may decide the MAG to be influenced by each of the flow filtering rules by referring to the information from the information service 350.

After acquiring the overlay network node (MAG) to be influenced or a list of the related filter rules, LMA can select the corresponding filter rule (or information of a part of the filter rules) and can update only the related MAG (MAG to be influenced) (Step S530). Or, transfer destination of a specific packet may be designated by specifying the value (address) of the destination MAG.

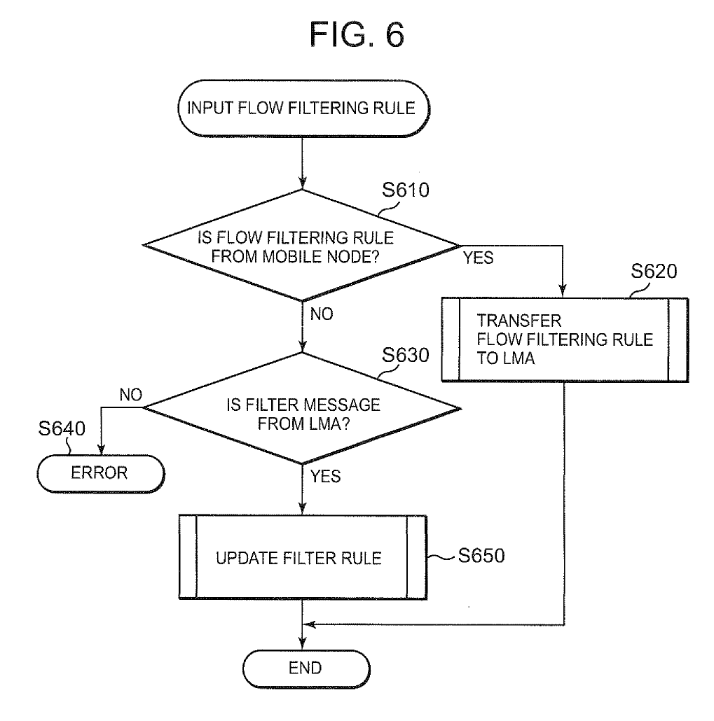

FIG. 6 shows an example of operation of MAG in the embodiment of the invention. When a packet containing the flow filtering rules arrives, MAG first checks whether the packet has been transmitted from the mobile node or not (Step S610). If the packet is the one transmitted from the mobile node, MAG transfers the packet containing the flow filter rule to LMA (S620).

If the packet is not the one transmitted from the mobile node but it is the one transmitted from LMA, MAG checks whether the filter message is present or not (Step S630). If a format of the filter message is not found, MAG gives error notification (error recovery processing) (Step S640).

On the other hand, in case a filter message is found, MAG performs an adequate processing to correspond to the filter message such as updating of the filter rule at the flow filtering protocol 430 or a processing to keep memory of the destination MAG to each rule (Step S650).

The present invention is not limited to selective updating of the flow filtering rules but may be used for the updating of any arbitrary functions (e.g. other functions used by the mobile node and not scalable). As the examples of such functions, there are path information where QoS (Quality of Service) is guaranteed or other types of topology-dependent information (information depending on network topology).

In case of the QoS-guaranteed path information, MN 1000 may request the establishment of the QoS-guaranteed path from CN 1090 to itself (MN 1000). In this case, all of the MAGs have no need to reserve network source of this path according to the present invention. Instead, resources are selectively reserved only at communication devices (MAG 1020, MAG 1040, and MAG 1060) on the path from CN 1090 to MN 1000.

The flow manager 330 may be disposed at any place in the network. For instance, it may be a central server disposed at a separated place. Also, the central server may be or may not be a part of NetLMM architecture. In case there is a central server, which has the functions of a flow manager, MAG transfers all filter rules to the central server. Then, the central server having the functions of the flow manager selects an MAG, which reflects the filter rule and distributes information of the necessary filter rules for each MAG to each selected MAG.

Also, the filter rule manager 410 may be present at a physically separated place. Or, the flow manager 330 and the filter rule manager 410 may co-exist within a single entity.

In the present specification, description has been given on an example where local IP mobility support by LMA and MAG as the arrangement of NetLMM infrastructure, while the present invention can also be applied to a case where local IP mobility support (PMIP; Proxy Mobile IP) based on PMIP-HA and PMA (Proxy Mobile Agent) is adopted. In this case, PMIP-HA corresponds to LMA, and PMA corresponds to MAG. It would be obvious to those skilled in the art that timing, combination, and division of each of the messages can be so modified that these can be used in the message system of PMIP.

According to the present invention, a communication device can also be provided, which is characterized in that the filter rules at the time of packet transfer as set up by a mobile node are registered in a communication device (e.g. LMA or the like) for the management of transfer destination of the packet to be transmitted by a localized mobility management protocol (e.g. NetLMM or the like). As a result, the filter rules can be collectively applied to the packets at a point where the packets such as LMA come together, and the filter rules can be more reliably applied. Also, the filter rules can be more easily applied to the packet transfer in the NetLMM.

In the present specification, description is given under the assumption that MN has a plurality of network interfaces, while it would suffice if there are a plurality of logical interfaces for the execution of the present invention. For instance, it may be so arranged that operation can be performed in a manner similar to the case where connection is made from a network unit to a network via a plurality of interfaces by designing that a single radio unit is commonly used in a plurality of connection modes, and that it can be switched over at a velocity, the change of which does not cause any problem from the viewpoint of network interface, or by maintaining logical link in the layer 2.

Also, even when MN has a single network interface, the method of the present invention can be used if the data flow for communication can be controlled.

In the present specification, illustrations and descriptions are provided by giving due consideration on such points that the embodiment of the invention will be the most practical and the most preferred example. Those skilled in the art would understand that various changes and modifications can be made without departing from the spirit and the scope of the invention in such points as the flow manager 330 or the details of design and parameters relating to the flow manager 330 and other component elements.

Each functional block used in the description of the embodiments of the present invention as given above can be realized as LSI (Large Scale Integration), typically represented by the integrated circuit. These may be produced as one chip individually or may be designed as one chip to include a part or all. Here, it is referred as LSI, while it may be called IC, system LSI, super LSI, or ultra LSI, depending on the degree of integration.

Also, the technique of integrated circuit is not limited only to LSI and it may be realized as a dedicated circuit or a general-purpose processor. FPGA (Field Programmable Gate Array), which can be programmed after the manufacture of LSI, or a reconfigurable processor, in which connection or setting of circuit cell inside LSI can be reconfigured, may be used.

Further, with the progress of semiconductor technique or other techniques derived from it, when the technique of circuit integration to replace LSI may emerge, the functional blocks may be integrated by using such technique. For example, the adaptation of biotechnology is one of such possibilities.

### INDUSTRIAL APPLICABILITY

The present invention provides such effects that the packet transmission in a network is optimized, and the invention can be applied to the field of communication technique in a system of packet-exchange type data communication network system. In particular, the present invention can be applied to the technique of mobile management (position management) of a mobile node, which is moving within a communication network domain, and also to the technique of the management of the packet transfer device in the network.

1. A network management device, being connectable to a network, and for managing transfer destination of a packet in said network, wherein said network management device comprises:
packet receiving means for receiving a packet from said network;
filter rule extracting means for extracting a filter rule at the time of packet transfer as set up by a mobile node from the packet received by said packet receiving means;
transfer path specifying means for specifying said packet transfer device, being influenced by said filter rule in a packet transfer device present within said network by inspecting said filter rule extracted by said filter rule extracting means; and
filter rule notifying means for extracting information necessary for said packet transfer device as specified by said transfer path specifying means from the information contained in said filter rules and for notifying the information to said packet transfer device as specified by said transfer path specifying means.

2. The network management device according to claim 1, wherein there is provided packet transfer destination notifying means for notifying a new transfer destination of said packet as defined in said filter rule to said packet transfer device as specified by said transfer path specifying means.

3. The network management device according to claim 1, wherein there is provided transfer destination acquiring means for acquiring a new transfer destination of said packet as defined in said filter rule.

4. A packet transfer device, being connectable to a network and for transferring a packet in said network, wherein said packet transfer device comprise:
filter rule storage means for storing a filter rule to define transfer condition to transfer a specific packet;
packet transfer means for transferring said packet according to said filter rule stored in said filter rule storage means;
filter rule receiving means for receiving a filter rule to define transfer condition of a specific packet from a network management device, being connected to said network and for managing transfer destination of said packet; and
filter rule updating means for updating said filter rule as stored in said filter rule storage means by using said filter rule received by said filter rule receiving means.

5. The packet transfer device according to claim 4, wherein said packet transfer device comprises:
filter rule request receiving means for receiving a filter rule to define transfer condition of a specific packet from a mobile node; and
filter rule transfer means for transferring said filter rule received by said filter rule request receiving means to a network management device, being connected to said network and for managing transfer destination of said packet.

6. The packet transfer device according to claim 4, wherein said packet transfer device comprises:
packet transfer destination acquiring means for acquiring a new transfer destination of said packet as defined by said filter rule; and
transfer destination memorizing means for memorizing said new transfer destination as acquired by said packet transfer destination acquiring means by associating with said filter rule, wherein:
said packet transfer means is so designed that said packet is transferred to said new transfer destination associated with said filter rule when said packet transfer means transfers said packet according to said filter rule.
